(19) United States
(12) Patent Application Publication
(10) Pub. No.: US 2020/0126381 A1
(43) Pub. Date: Apr. 23, 2020

(54) MONITORING STATION WITH SYNCHRONISED PLAYBACK OF DETECTED EVENTS

(71) Applicant: Carrier Corporation, Jupiter (FI)

(72) Inventors: Michael Yudichak, Fairport, NY (US); Randall Ellis Church, Rochester, NY (US)

(21) Appl. No.: 16/500,257

(22) PCT Filed: Apr. 6, 2018
(86) PCT No.: PCT/US2018/026492

§ 371 Date: Oct. 2, 2019

Related U.S. Application Data
(60) Provisional application No. 62/483,637, filed on Apr. 10, 2017.

(51) Int. Cl. G08B 13/196

(52) U.S. Cl. CPC G08B 13/19682; G08B 13/19693; G08B 13/19606; G08B 13/19673

(57) ABSTRACT

A monitoring system is provided for a defined space. The monitoring system includes a plurality of sensor elements distributed throughout the defined space, a plurality of alarms distributed throughout the defined space and a monitoring station. The monitoring station is receptive of information from the respective pluralities of the sensor elements and the alarms. The monitoring station is configured to generate from the information a device list, an alarm and event list, a layout of audio/video playback windows, a playback control interface and a standard timeline representing a standard playback time of audio signals and videos being played in the audio/video playback windows.

### BACKGROUND

The following description relates to playback controls and, more particularly, to security monitoring systems with alarms and audio/video playback controls.

When security monitoring operators need to investigate an incident, they typically load a log (or trace) of events in a certain timeframe for a certain set of hardware elements. These include panels, readers, intrusion points, motion detectors, etc. They will also launch video playback applications for multiple cameras in that same timeframe in order to determine what is happening visually in the facility surrounding the log of events. This often done by way of a manual process and requires calculations for understanding the sequence of events compared to video playback conditions during a past timeframe.

### BRIEF DESCRIPTION

According to one aspect of the disclosure, a monitoring system is provided for a defined space. The monitoring system includes a plurality of sensor elements distributed throughout the defined space, a plurality of alarms distributed throughout the defined space and a monitoring station. The monitoring station is receptive of information from the respective pluralities of the sensor elements and the alarms. The monitoring station is configured to generate from the information a device list, an alarm and event list, a layout of audio/video playback windows, a playback control interface and a standard timeline representing a standard playback time of audio signals and videos being played in the audio/video playback windows.

In accordance with additional or alternative embodiments, the monitoring system further includes a network by which the monitoring station is communicative with the respective pluralities of the sensor elements and the alarms.

In accordance with additional or alternative embodiments, the plurality of sensor elements includes cameras distributed throughout the defined space.

In accordance with additional or alternative embodiments, the plurality of sensor elements further includes at least one of motion detectors, microphones and optical detectors.

In accordance with additional or alternative embodiments, the plurality of alarms includes at least one of door and window alarms.

In accordance with additional or alternative embodiments, the monitoring station includes at least one display unit configured to display the device list, the alarm and event list, the layout of audio/video playback windows, the playback control interface and the standard timeline.

In accordance with additional or alternative embodiments, the audio/video playback windows are configured to automatically synchronize the audio signals and videos played therein.

In accordance with additional or alternative embodiments, the standard timeline includes an advancing time-stamp superimposed over the audio signals and videos.

According to another aspect of the disclosure, a monitoring station of a monitoring system for a defined space is provided. The monitoring station is receptive of information from respective pluralities of sensor elements and alarms distributed throughout the defined space. The monitoring system includes at least one display unit which is configured to display monitoring elements generated from the information. The monitoring elements include a device list, an alarm and event list, a layout of audio/video playback windows, a playback control interface and a standard timeline representing a standard playback time of audio signals and videos being played in the audio/video playback windows.

In accordance with additional or alternative embodiments, the monitoring station further includes a network by which the information is receivable from the respective pluralities of the sensor elements and the alarms.

In accordance with additional or alternative embodiments, the plurality of sensor elements includes cameras distributed throughout the defined space.

In accordance with additional or alternative embodiments, the plurality of sensor elements further includes at least one of motion detectors, microphones and optical detectors.

In accordance with additional or alternative embodiments, the plurality of alarms includes at least one of door and window alarms.

In accordance with additional or alternative embodiments, the audio/video playback windows are configured to automatically synchronize the audio signals and videos played therein.

In accordance with additional or alternative embodiments, the standard timeline includes an advancing time-stamp superimposed over the audio signals and videos.

According to yet another aspect of the disclosure, a method of operating a monitoring system for a defined space is provided. The method includes distributing a plurality of sensor elements throughout the defined space, distributing a plurality of alarms throughout the defined space, receiving, at a monitoring station comprising a display unit, information from the respective pluralities of the sensor elements and the alarms and generating, at the monitoring station, monitoring elements from the information for display on the display unit. The monitoring elements include a device list, an alarm and event list, a layout of audio/video playback windows, a playback control interface and a standard timeline representing a standard playback time of audio signals and videos being played in the audio/video playback windows.

In accordance with additional or alternative embodiments, the receiving of the information includes receiving the information via a network.

In accordance with additional or alternative embodiments, the plurality of sensor elements comprises cameras distributed throughout the defined space, at least one of motion detectors, microphones and optical detectors and at least one of door and window alarms.

In accordance with additional or alternative embodiments, the method further includes automatically synchronizing the audio signals and videos played in the audio/video playback windows.

In accordance with additional or alternative embodiments, the method further includes superimposing an advancing time-stamp over the audio signals and videos.

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of a floor plan of a bank with components of a monitoring system in accordance with embodiments;

FIG. 2 is an elevational view of a monitoring station of the monitoring system of FIG. 1;

FIG. 3 is a schematic illustration of connections between the monitoring station of FIG. 2 and the components of the monitoring system of FIG. 1;

FIG. 4 is a graphical display of monitoring elements of the monitoring station in accordance with embodiments;

FIG. 5 is a screenshot of a blank investigation screen in accordance with embodiments;

FIG. 6 is a screenshot of a selection of a timeframe in the blank investigation screen of FIG. 5;

FIG. 7 is a screenshot of a selection of a sensor, camera or device in the blank investigation screen of FIG. 5;

FIG. 8 is a screenshot of a data loading operation in accordance with embodiments;

FIG. 9 is a collection of screenshots of a timeline being played in accordance with embodiments; and

FIG. 10 is a screenshot indicating that an operator will have an opportunity to add notes to a display in accordance with embodiments.

### DETAILED DESCRIPTION

As will be described below, a system and method are provided by which a security monitoring operator is able to watch alarms and/or events and live audio and/or video and easily understand the context of what is happening in the subject environment. That is, by synchronizing the events and audio signals and/or video and adding playback controls, the operator can interpret historic data as if it were happening live because recorded audio signals and/or video from one or multiple cameras along with events or alarms from security devices will have the ability to be played back as if the incident was happening live. Playback controls will allow for self-paced review of the alarms and the audio signals and/or videos.

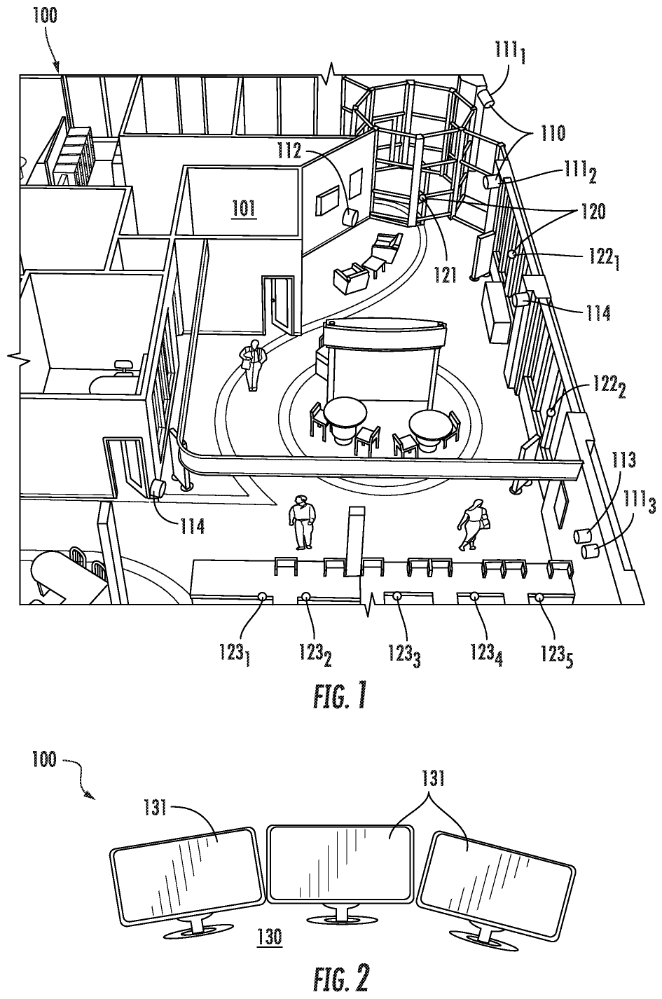

With reference to FIGS. 1-4, a monitoring system 100 is provided for use with a defined interior and/or exterior space 101. The defined interior and/or exterior space 101 can be any spatial region and is illustrated in FIG. 1 as an interior of a bank and an exterior area surrounding the bank.

The monitoring system 100 includes a plurality of sensor elements 110 that are distributed throughout the defined interior and/or exterior space 101, a plurality of alarms 120 distributed throughout the defined interior and/or exterior space 101 and a monitoring station 130 (see FIG. 2). In accordance with embodiments, the plurality of sensor elements 110 may include cameras 111 and at least one or more of motion detectors 112, microphones 113 and optical detectors 114 and the plurality of alarms 120 may include at least one or more of door alarms 121, window alarms 122 and hidden teller alarms 123.

As shown in FIG. 1, the respective pluralities of the sensor elements 110 and the alarms 120 are distributed throughout the defined interior and/or exterior space 101 in order to provide for security and coverage of substantially all of the defined interior and/or exterior space 101. Thus, the plurality of the sensor elements 110 includes a first camera 111₁ outside of a front door, a second camera 111₂ in an interior walkway, a third camera 111₃ proximate to teller windows, a motion detector 112 inside the front door near the floor, a microphone 113 proximate to the teller windows and an optical detector 114 in a central portion of the interior walkway. Similarly, the plurality of the alarms 120 includes a door alarm 121, first and second window alarms 122₁ and 122₂ and first-fifth hidden teller alarms 123₁₋₅.

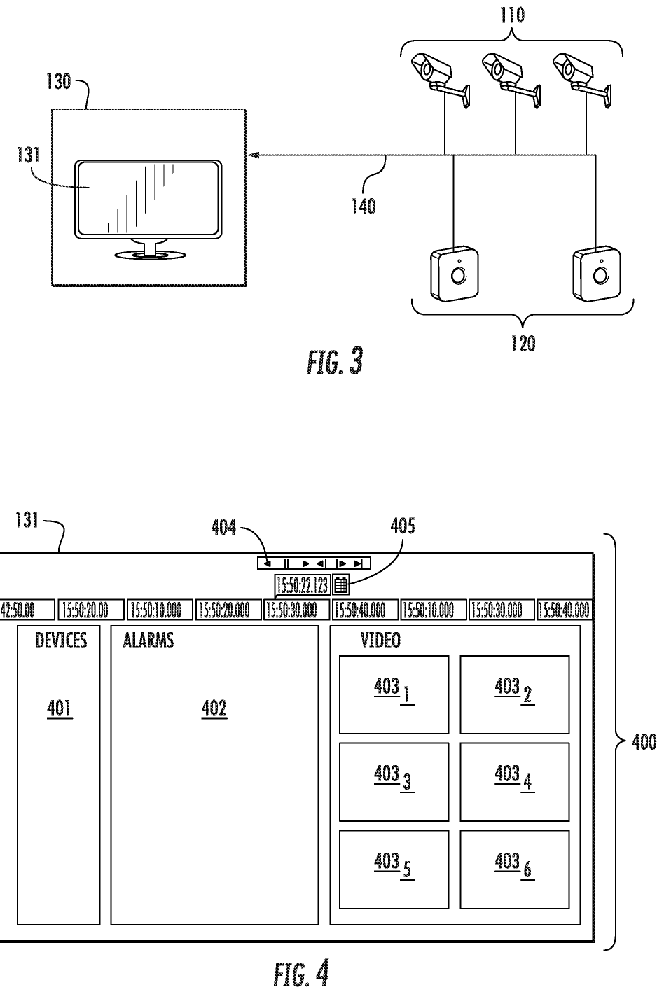

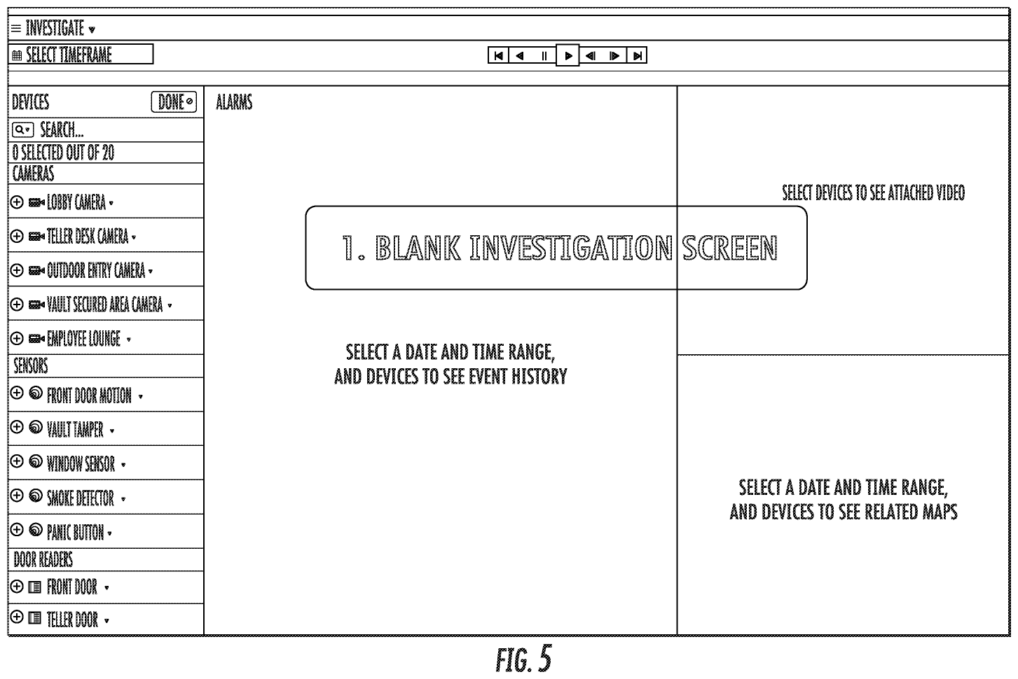

The monitoring station 130 may include at least one or more display unit 131 (three display units 131 are illustrated in FIG. 2) and is receptive of information from the respective pluralities of the sensor elements 110 and the alarms 120. The monitoring station 130 may be communicative with the respective pluralities of the sensor elements 110 and the alarms 120 via a wired or wireless network 140 (see FIG. 3). In any case, as shown in FIG. 4, the monitoring station 130 is configured to generate monitoring elements 400 from the received information. The monitoring elements 400 are displayable on the at least one or more display unit 131. As displayed and, in accordance with embodiments, the monitoring elements 400 include a device list 401, an alarm and event list 402, a layout of audio/video playback windows 403, a playback control interface 404 and a standard timeline 404. Here, the standard timeline 404 represents a standard playback time of videos being played in the audio/video playback windows 403.

The device list 401 may be provided as a list of all of the components of the respective pluralities of the sensors 110 and the alarms 120. As such, for the embodiments of FIG. 1, the device list 401 may include a listing of the first camera 111₁, the second camera 111₂, the third camera 111₃, the motion detector 112, the microphone 113, the optical detector 114, the door alarm 121, the first and second window alarms 122₁ and 122₂ and the first-fifth hidden teller alarms 123₁₋₅. The alarm and event list 402 may be provided as a list of all of the alarms and events picked up or detected by the respective pluralities of the sensors 110 and the alarms 120. The layout of audio/video playback windows 403 provides for playback of audio signals and/or videos recorded by each of the cameras and any other audio/visual devices. Thus, audio/video playback window 403₁ may be configured to playback video recorded by the first camera 111₁, audio/video playback window 403₂ may be configured to playback video recorded by the second camera 111₂, audio/video playback window 403₃ may be configured to playback video recorded by the third camera 111₃, fourth audio/video playback window 403₄ may be configured to playback video recorded by the motion detector 112, fifth audio/video playback window 403₅ may be configured to playback video recorded by the microphone 113 and sixth audio/video playback window 403₆ may be configured to playback video recorded by the optical detector 114. The playback control interface 404 includes at least play, fast-forward, rewind and pause buttons to allow a user to control the audio/visual playback of each of the audio/video playback windows 403.

In accordance with embodiments, the monitoring station 130 may be configured to automatically synchronize the audio signals and videos being played back in the audio/video playback windows 403 with each other, with all of the alarms and events included in the alarm and event list 402 and with an advancing standard time that may be superimposed over the audio signals and the videos being played back.

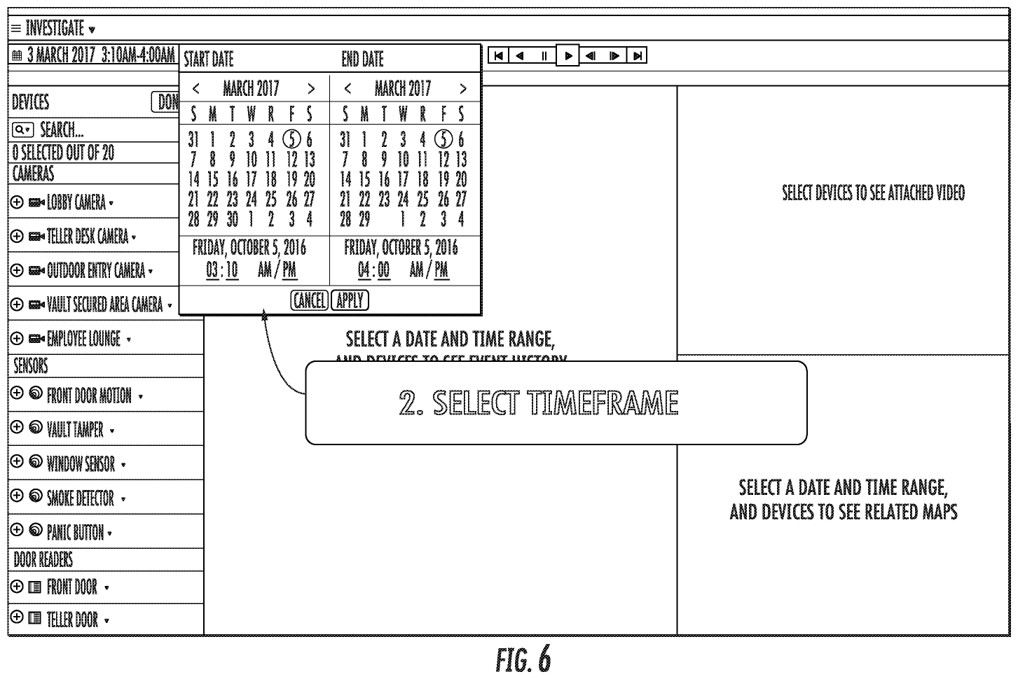

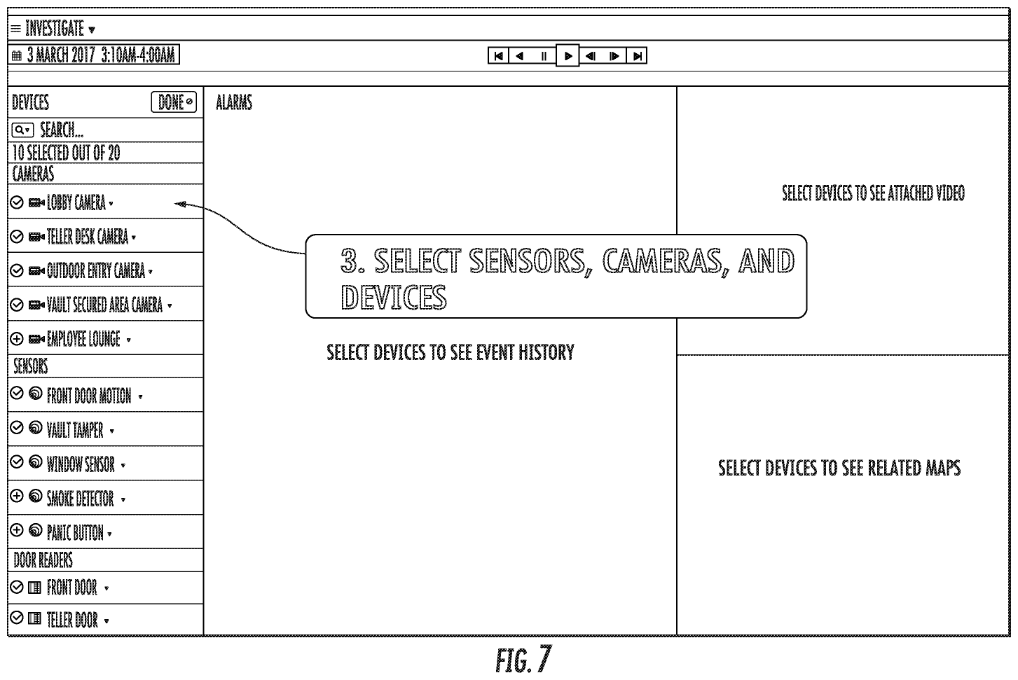

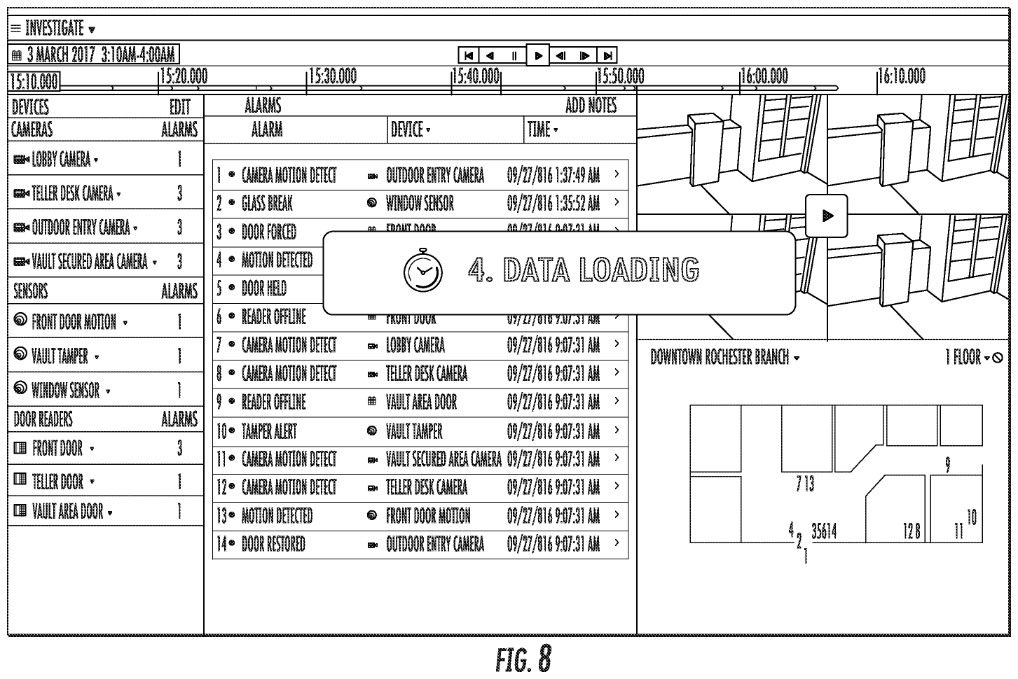

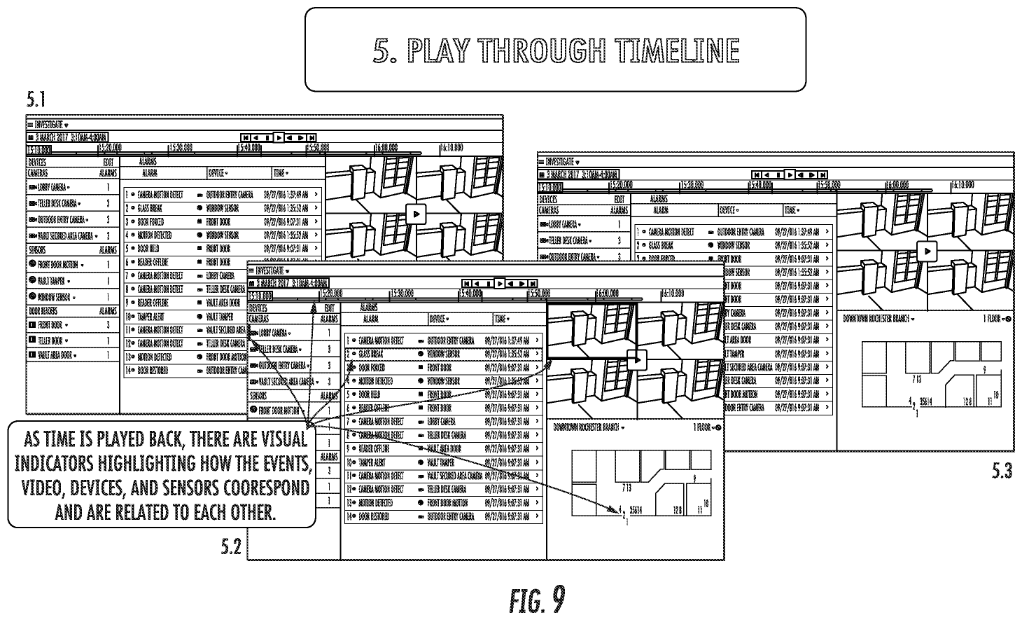

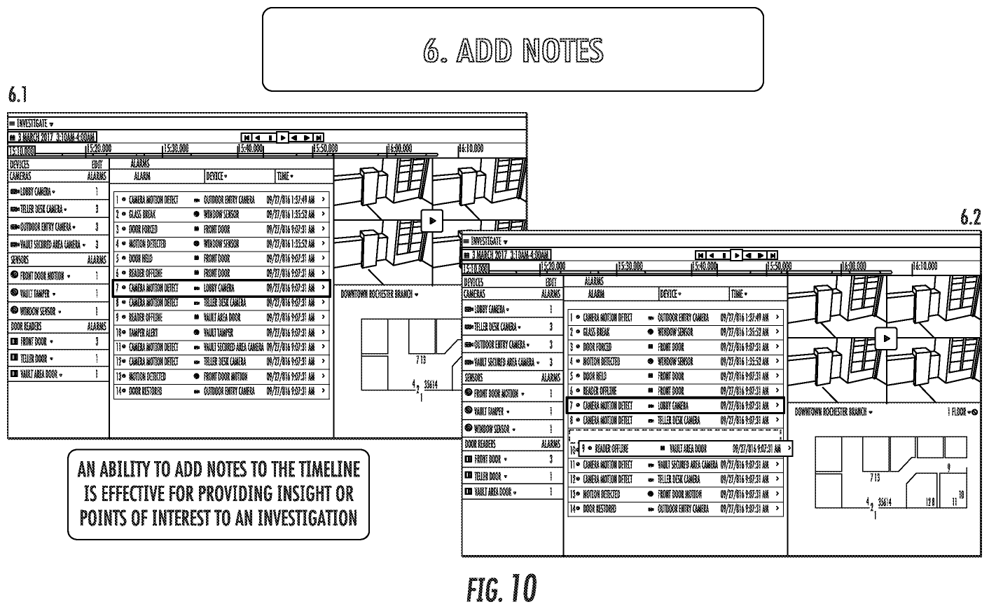

With reference to FIGS. 5-10, a set of screenshots are provided to illustrate an execution of the system and methods described herein. As shown in FIGS. 5-7, a blank investigation screen is initially provided (see FIG. 5) whereupon a user selects a given timeframe (see FIG. 6) and a sensor, a device or a camera (see FIG. 7). Once these user selections are complete, data is loaded into the main frame of the display as shown in FIG. 8 and, subsequently, the user can have the video(s) associated with his selections played back as shown in FIG. 9 and can input notes for providing insight or points of interest to an investigation into the playback as shown in FIG. 10. In particular, during the playback, there can be visual indicators provided to highlight how events, video, devices and sensors correspond and relate to each other. A section for a map can also be provided. Such a map would be valuable as a visual representation of the space in which the sensors, cameras, devices and doors exist. The map(s) will have visual indicators that highlight when and where events occur on the timeline.

In accordance with further embodiments, the video(s) that were played back and annotated as described above with reference to FIGS. 9 and 10 can be exported or otherwise forwarded to an authorized recipient (e.g., a building administrator or the police).

By synchronizing the playback of alarms and video, the systems and methods described above will allow for a clearer understanding of how security incidents transpired in the past. Playback controls and a timeline will allow for a self-paced investigation and aid in a more efficient investigation rather than relying on constant back and forth references to a log of data.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A monitoring system for a defined space, comprising:
a plurality of sensor elements distributed throughout the defined space;
a plurality of alarms distributed throughout the defined space; and
a monitoring station which is receptive of information from the respective pluralities of the sensor elements and the alarms,
the monitoring station being configured to generate from the information:
a device list,
an alarm and event list,
a layout of audio/video playback windows,
a playback control interface, and
a standard timeline representing a standard playback time of audio signals and videos being played in the audio/video playback windows.

2. The monitoring system according to claim 1, further comprising a network by which the monitoring station is communicative with the respective pluralities of the sensor elements and the alarms.

3. The monitoring system according to claim 1, wherein the plurality of sensor elements comprises cameras distributed throughout the defined space.

4. The monitoring system according to claim 3, wherein the plurality of sensor elements further comprises at least one of motion detectors, microphones and optical detectors.

5. The monitoring system according to claim 1, wherein the plurality of alarms comprises at least one of door and window alarms.

6. The monitoring system according to claim 1, wherein the monitoring station comprises at least one display unit configured to display the device list, the alarm and event list, the layout of audio/video playback windows, the playback control interface, and the standard timeline.

7. The monitoring system according to claim 6, wherein the audio/video playback windows are configured to automatically synchronize the audio signals and videos played therein.

8. The monitoring system according to claim 7, wherein the standard timeline comprises an advancing time-stamp superimposed over the audio signals and videos.

9. A monitoring station of a monitoring system for a defined space, the monitoring station being receptive of information from respective pluralities of sensor elements and alarms distributed throughout the defined space and comprising:
at least one display unit which is configured to display monitoring elements generated from the information, the monitoring elements comprising:
a device list;
an alarm and event list;
a layout of audio/video playback windows;
a playback control interface; and
a standard timeline representing a standard playback time of audio signals and videos being played in the audio/video playback windows.

10. The monitoring station according to claim 9, further comprising a network by which the information is receivable from the respective pluralities of the sensor elements and the alarms.

11. The monitoring station according to claim 9, wherein the plurality of sensor elements comprises cameras distributed throughout the defined space.

12. The monitoring station according to claim 11, wherein the plurality of sensor elements further comprises at least one of motion detectors, microphones and optical detectors.

13. The monitoring station according to claim 9, wherein the plurality of alarms comprises at least one of door and window alarms.

14. The monitoring station according to claim 9, wherein the audio/video playback windows are configured to automatically synchronize the audio signals and videos played therein.

15. The monitoring system according to claim 14, wherein the standard timeline comprises an advancing time-stamp superimposed over the audio signals and videos.

16. A method of operating a monitoring system for a defined space, the method comprising:
distributing a plurality of sensor elements throughout the defined space;
distributing a plurality of alarms throughout the defined space;
receiving, at a monitoring station comprising a display unit, information from the respective pluralities of the sensor elements and the alarms; and
generating, at the monitoring station, monitoring elements from the information for display on the display unit,
the monitoring elements comprising a device list, an alarm and event list, a layout of audio/video playback windows, a playback control interface and a standard timeline representing a standard playback time of audio signals and videos being played in the audio/video playback windows.

17. The method according to claim 16, wherein the receiving of the information comprises receiving the information via a network.

18. The method according to claim 16, wherein the plurality of sensor elements comprises cameras distributed throughout the defined space, at least one of motion detectors, microphones and optical detectors and at least one of door and window alarms.

19. The method according to claim 16, further comprising automatically synchronizing the audio signals and videos played in the audio/video playback windows.

20. The method according to claim 19, further comprising superimposing an advancing time-stamp over the audio signals and videos.
